(19) United States
(12) Patent Application Publication
(10) Pub. No.: US 2020/0161896 A1
(43) Pub. Date: May 21, 2020

(54) Power Supply System for Wireless Power Transfer

(71) Applicant: TDK Electronics AG, München (DE)

(72) Inventors: Pierre Fechting, Solothurn (CH); Fabian Beck, Rüttenen (CH)

(21) Appl. No.: 16/497,418

(22) PCT Filed: Mar. 24, 2017
(86) PCT No.: PCT/EP2017/057085

§ 371 Date: Sep. 24, 2019

(51) Int. Cl. H02J 50/10; H04B 5/00

(52) U.S. Cl. CPC H02J 50/10; H02J 2207/10; H04B 5/0037; H04B 5/0081

(57) ABSTRACT

A power supply system for wireless power transfer is disclosed. In an embodiment, a power supply system includes a pickup coil and a converter with a power output port, wherein the power supply system is configured to receive power from a (wireless power transfer) WPT system having a primary coil, and wherein the power supply system is insulated from the primary coil of the WPT system.

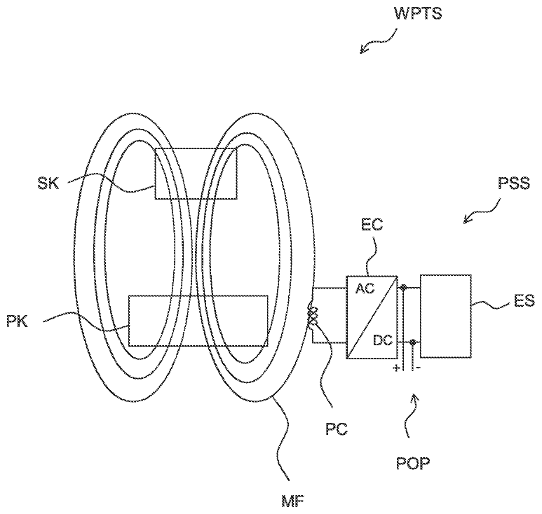

This patent application is a national phase filing under section 371 of PCT/EP2017/057085, filed Mar. 24, 2017, which is incorporated herein by reference in its entirety.

### TECHNICAL FIELD

The present invention refers to a power supply system, e.g., for WPT systems.

### BACKGROUND

WPT systems (WPT=Wireless Power Transfer) can be utilized to transfer electric power towards a device without the need for a physical connection. E.g., handheld devices such as mobile communication devices or automobiles can be provided with electric power via such systems.

To that end, a WPT system can have a primary coil and a secondary coil. The primary coil may be connected to a power supply terminal and may be utilized to transmit power in the form of a time dependent magnetic field. The secondary coil may be a reception coil that receives magnetic power emitted by the primary coil. The secondary coil can provide electric power to a circuit environment without a direct electrical connection to the power supply terminal of the primary coil.

The secondary coil, thus, has no direct and permanent energy supply. However, it may be possible that at a specific time a circuit environment in the vicinity of the primary coil needs power while the secondary coil cannot provide power.

### SUMMARY OF THE INVENTION

Embodiments provide a power supply system that decreases dependencies from known power supplies.

Various embodiments provide a power supply system comprising a pickup coil and a converter with a power output port. The power supply system is provided to receive power from a WPT system. The WPT system has a primary coil. The power supply system is insulated from the WPT system's primary coil.

The WPT system can have one or more further coils. The primary coil can be a transmission coil for transmitting power. A secondary coil can be a reception coil. However, it is also possible that the primary coil is a reception coil and the secondary coil is a transmission coil.

Thus, it is possible that the present power supply system is additionally insulated from the secondary coil, too. In general, it is possible that the present power supply system is insulated from the WPT system as a whole.

WPT systems have the major advantage that no physical contact between an energy providing element (e.g., the primary coil) and an energy receiving element (e.g., the secondary coil) is needed. Additionally, it is possible that power can be transferred, even if the providing element and the receiving element are not perfectly aligned relative to each other. However, the power transfer rate and the power transfer efficiency are reduced with increasing misalignment.

To counteract a decrease in power transfer rate or power transfer efficiency it is possible to control the power transfer process with adjustments in the circuit of the primary coil or adjustments in the secondary coil. But while the primary coil and its direct circuit environment are usually provided with electric energy, the secondary coil and its direct circuit environment is not. Correspondingly, the problem arises that to improve the power transfer to the secondary coil with actions taken at the secondary coil's side, power is not available.

Further, other circuits that are arranged in the vicinity of a primary coil and that would need power from the primary or a secondary coil are possible.

To provide power to such circuits the present power supply system is well suited.

The pickup coil can be provided in such a shape, at such a location and with such a circuit environment that the dependency of power transfer to the pickup coil is less distinct than the dependency of the power transfer to a secondary coil. Also, the power rate of power transfer to the pickup coil can be significantly lower than the power rate of power transfer to the secondary coil where emphasis is on a high power transfer efficiency is a matched state.

Thus, as a high power transfer efficiency may not be a primary goal of the pickup coil, emphasis can be on a reliability of transferring a certain minimum of power rate to the pickup coil.

With such a power supply system the control system of a WPT system can be powered to subsequently increase power efficiency and power transfer rate to the WPT systems secondary coil.

It is possible that the converter comprises an AC/DC converter.

The pickup coil receives power at a frequency that may be in the range of a working frequency of a WPT system, e.g., between 81 kHz and 90 kHz. An AC/DC (AC=Alternating Current/DC=Direct Current) converter converts power provided by the pickup coil in the form of an alternating current to power in the form of a direct current.

It is possible that the power supply system the converter comprises a switch to disconnect the power output port from the pickup coil.

The power supply system may supply power to a control system, to a communication system, or to a similar system. The power consumption of such systems may be orders of magnitude smaller than systems provided by the secondary coil as only logic circuits, semiconductor switches or relays may be powered. The circuits provided by the present power supply systems may need a supply power between 1 and 50 W while the secondary coil of the WPT system (e.g., in a WPT system for charging a primary battery in an electric powered automobile) may need to provide a power in the range of 1 kW to 10 kW. Thus, e.g., if the power transfer efficiency is increasing during optimization processes, the converter can disconnect circuitry from the pickup coil if appropriate.

The power supply system may include an energy storage.

Such an energy storage may be a rechargeable battery, a capacitor, a capacitor array or a similar storage, preferably an energy storage for electric energy.

Then, e.g., in the case of a system for charging the primary battery of an electrically driven automobile, communication protocols and verifications, e.g., concerning the secondary coil's identity, can be performed before the primary coil is activated because the energy storage provides the necessary energy at the receiver side. Also, a preferred power range can be transmitted to the side of the primary coil.

It is possible that the WPT system has a secondary coil.

Then, it is possible that the power supply system is insulated from the secondary coil, too.

The WPT system's primary coil can be used to transmit power to the secondary coil to benefit from the above mentioned advantages.

It is possible that the power supply system is provided to supply power to a control system or a measurement device.

This reception system can be any sensible system that can then be powered without the risk of over voltages.

A measurement system can be used to determine the power transfer efficiency to a secondary coil, a current in a secondary coil, a voltage provided by a secondary coil and the like.

Correspondingly, the present power supply system can be provided to supply power to the WPT system. In particular, the present system can be utilized to provide supply power to the reception side of a WPT system, e.g., a circuit environment of a secondary coil.

A WPT system comprises a primary coil, a secondary coil and a power supply system as described above.

Thus, the power supply system described above can be a part of a WPT system, e.g., to improve the power-on process. However, the present power supply system can be used separately and independent from a receiver side of a WPT system. Then, the present power supply system can be used to power additional systems.

The pickup coil can be utilized to extract power from the power transmitted from the primary coil to its environment, e.g., to a secondary coil. However, the amount of power routed to the pickup coil is preferably small compared to the power which should be received by the secondary coil. Thus, the power transfer to the pickup coil should not essentially disturb the power transfer to the secondary coil.

Thus, the system can be utilized to extract power from a power flux of a WPT system to power one or more auxiliary systems.

### BRIEF DESCRIPTION OF THE DRAWINGS

Working principles of the present power supply system and details of preferred embodiments are shown in the accompanying FIGURE.

The sole FIGURE shows a power supply system and a wireless power transfer according to embodiments.

### DETAILED DESCRIPTION OF ILLUSTRATIVE EMBODIMENTS

The FIGURE shows the relationship between the power supply system PSS and a WPT system WPTS. The power supply system has a pickup coil PC, an energy converter EC and a power output port POP. The pickup coil is preferable arranged in a vicinity, i.e., in an effective range, of a primary coil PK of the WPT system WPTS.

The FIGURE shows corresponding cross sections through the primary coil and the secondary coil.

The converter EC can be or can comprise an AC/DC converter. The presence of an AC/DC converter is optional.

The power supply system PSS can have an energy storage ES. The presence of an energy storage is optional.

The WPT system can have a secondary coil SK. The presence of a secondary coil as a part of the WPT system is optional but preferred.

A magnetic field MF which can be an alternating field with a working frequency of approximately 85 kHz can be used to transfer power from the primary coil PK to the secondary coil SK. To improve a power transfer rate or a power transfer efficiency adaptions can be made at the receiver side with the secondary coil. To that end, e.g., as the power transfer rate is initially to low, circuits such as a control circuit at the receiver side can be powered by the power supply system PSS. The power supply system PSS provides power at its power output port POP.

Energy from the energy storage ES can be utilized to power circuits even before the pickup coil PC itself receives enough power.

The power supply system and the WPT system including a power supply system are not limited by the described embodiments and their technical details and the circuit elements shown in the figure. The power supply systems can have further circuit elements, e.g., sensors, coils and a control logic.

1-9. (canceled)

10. A power supply system comprising:
a pickup coil; and
a converter with a power output port,
wherein the power supply system is configured to receive power from a (wireless power transfer) WPT system having a primary coil, and
wherein the power supply system is insulated from the primary coil of the WPT system.

11. The power supply system of claim 10, wherein the converter comprises an AC/DC converter.

12. The power supply system of claim 10, wherein the converter comprises a switch configured to disconnect the power output port from the pickup coil.

13. The power supply system of claim 10, further comprising an energy storage.

14. The power supply system of claim 10, wherein the WPT system has a secondary coil.

15. The power supply system of claim 14, wherein the power supply system is insulated from the secondary coil.

16. The power supply system of claim 10, wherein the power supply system is configured to supply power to a control system or a measurement device.

17. The power supply system of claim 10, wherein the power supply system is configured to supply power to the WPT system.

18. A WPT system comprising:
a primary coil;
a secondary coil; and
the power supply system of claim 10.

19. A power supply system comprising:
a pickup coil; and
a converter with a power output port,
wherein the power supply system is configured to receive power from a WPT (wireless power transfer) system having a primary coil and a secondary coil,
wherein the power supply system is insulated from the primary coil and the secondary coil of the WPT system, and
wherein the power supply system is configured to supply power to a control system or a measurement device.
